(19) United States
(12) Patent Application Publication
(10) Pub. No.: US 2015/0155742 A1
(43) Pub. Date: Jun. 4, 2015

(54) BATTERY STORAGE RACK

(71) Applicant: STEVAN M. BAILEY, Yorba Linda, CA (US)

(72) Inventor: STEVAN M. BAILEY, Yorba Linda, CA (US)

(21) Appl. No.: 14/093,198

(22) Filed: Nov. 29, 2013

(51) Int. Cl. H02J 9/00

(52) U.S. Cl. CPC H02J 9/00

(57) ABSTRACT

The invention includes a storage rack for storing an array of battery cells in an uninterrupted power source that meets the seismic testing requirements of NEBS GR-63-CORE (Issue 2 Apr. 2002). Embodiments of the present invention include locking tabs on front and rear horizontal rails positioned between each horizontal shelf member and spaced as needed between battery cells as desired. Further embodiments of the present invention include ventilation holes formed in the horizontal shelf member and aligned with the locking tabs to provide ventilation between the battery cells. Further embodiments of the present invention further include battery guides formed in the horizontal shelf member and aligned with the locking tabs to guide the battery cells on the horizontal shelf member and ease installation of the battery cells.

### CROSS-REFERENCE TO RELATED APPLICATIONS

This application claims the benefit of U.S. Provisional Application No. 61/797,134, filed Nov. 29, 2012, the disclosure of which is incorporated herein by reference.

### FIELD OF THE INVENTION

The present invention relates to battery storage racks, and more particularly relates to a seismic-resistant battery storage racks particularly suited for securely storing an array of battery cells comprising an uninterruptible power source. In particular, the present invention provides tor locking tabs in the storage rack that contact and separate adjacent battery cells and prevents the battery cells from shifting within the storage rack during movement of the storage rack.

### BACKGROUND

There are many configurations and applications of general storage racks known in the industry including for warehouse storage, retail storage, lumber storage and limitless other applications. Many storage racks are designed for transient storage of items, while others are designed for longer term or semi-permanent storage. Storage racks generally have few requirements beyond structural integrity unless required for specialty applications. One such specialty application is in the telecommunications or other industry where there is need for the semi-permanent storage of backup power supplies consisting of racks of low voltage batteries.

Embodiments of the present invention relate to protective containers for such backup power supplies, and in particular an enclosure system and methods for protecting the telecommunications equipment from shaking damage including that caused by an earthquake or other seismic movement. Telecommunication systems connected to power lines and telephone wires are particularly vulnerable to the effects of shaking, which generally will create a natural disaster when such telecommunications are most in need of reliable backup power source.

The battery cells for these backup power supplies can be large, contain caustic materials and are relatively heavy. While stored they are electrically connected to the power grid as well as a power source for charging and produce much heat as they continuously undergo the cycle of discharging and charging such that they are always nearly fully charged and available for use. As a result of the creation of heat, adequate ventilation through any storage rack is needed to avoid overheating of the batteries which may lead to a reduced effective life. Additionally, a result of the natural heating of the batteries through charge and discharge, the batteries tend to swell and so space and gaps between adjacent batteries must be provided to accommodate such swelling or bulging.

In the prior art it is industry-wide practice to use battery cell spacers consisting of cut sheets of one-half inch thick rigid plastic foam as gap spacers between battery cells. If the battery casings maintain the same size and shape, such a solution is satisfactory, although it does not permit ventilation between the cells. Further, such practice does not provide a complete blockage to battery movement or shifting during a seismic activity. Some practice is also made of pins or rods to separate batteries, but this may interfere with the natural battery bulging and could create damage. The bulging usually begins at a low level, increases to a maximum at the middle of the cell casing and then recedes to essentially normal dimensions at the top of the cell casing and the cover. Thereafter the battery casings are forced apart by the continuing bulging. Since connections between posts of opposite polarity in adjacent cells are frequently made of heavy conductive metal, typically lead alloy connectors, which are rigidly connected to the respective posts, movement of the cases relative to one another, resulting from bulging, sometimes results in bending of terminal posts and/or breaking of the seals between the battery case and the terminal.

As the battery arrays are electrically connected they must not move such that they could shift or fall and dislodge the electrical connections or release the caustic materials inside. Such potential movement would likely come at the time of an emergency when the main power grid is compromised and the backup batteries are most needed.

The telecommunications industry and other industries use backup power supplies or “uninterruptible power sources” (UPS's) to maintain operations when primary power sources fail or are interrupted. These UPS's are used to supply backup power to critical electrical and electronic equipment during primary power interruptions. Often these backup power sources include arrays of 2-volt valve-regulated lead acid battery cells (VRLA's). For example, a 48-volt backup power supply may include an array of twenty-four 2-volt VRLA's interconnected in series to supply backup power to critical equipment. Alternatively, a 24-volt backup power supply may include an array of twelve 2-volt VRLA's. These battery cells typically are supported on racks in a desired array. One such metal rack is described in U.S. Pat. No. 6,719,150. Such racks may support battery cells in a 3 by 8 array (48-volt array), or in a 3 by 4 array (24-volt army), for example. depending upon the desired or required amount of backup power.

The telecommunications industry has widely adopted to set of industry standards known as the NEBS (“Network Equipment-Building System”) standards. The NEBS standards were developed by Bell Labs in the 1970's to standardize equipment that would eventually be installed in either an incumbent Local Exchange Carrier (ILEC) or Regional Boll Operating Company (RBOC) Central Office. The NEBS standards basically describe the environment of as typical or generic RBOC Central Office. Bell Labs' intent in developing the NEBS standards was to make it easier for vendors to design and supply equipment compatible with as generic RBOC Central Office environment.

The main NEBS standard is Bellcore (now Telcordia) GR-63-CORE “Network Equipment-Building System NEBS) Requirements: Physical Protection” Section 4.4, entitled “Earthquake, Office Vibration, and Transportation Vibration,” provides generic criteria for earthquake, office vibration, and transportation vibration for telecommunications network equipment. Section 4.4.1 entitled “Earthquake Environment and Criteria” defines the seismic shaking conditions that must be withstood by a particular piece of equipment to be NEBS certified. This section requires the equipment to withstand a most severe “Zone 4 seismic event,” which is approximately equivalent to an earthquake having a rating of 8.2 on the Richter scale. GR-63-CORE section 54.1 defines the waveform testing requirements necessary to demonstrate NEBS GR-63-CORE seismic compliance.

Current approaches for protecting telecommunications racks and enclosures from seismic movement are often costly, however, and riot well suited for efficient use with standard sized telecommunications battery cells and components and often fail to provide means of stabilizing the battery cells within the enclosure. For example, in some eases custom storage racks in rooms are built to store telecommunications battery arrays. In other cases, vendors lease multiple telecommunications rooms or spaces in which to store vast arrays of battery cells to maintain adequate redundancy for such emergency situations.

What is needed are improved battery storage rack protection systems and methods that provide secure stabilization of standard telecommunications backup power sources, while utilizing minimal floor space or meeting other spatial dimension requirements for a telecommunications room or space. Embodiments of the present invention address such needs.

While some battery storage racks and systems may be available that claim to pass the NEBS GR-63-CORE (Issue 2 Apr. 2002) seismic testing requirements, most provide no restraint on the batteries shifting or moving within a shelf. While the storage rack structure itself may resist damage, the shifting batteries may damage not only the batteries themselves, but also may stretch, break or deform the connecting cables, disrupting the effective delivery of power from the batteries to the telecommunications network. Prior shelving systems may include gaps or spacing, perhaps with bumps or pins between the adjacent battery cells to allow fie cooling ventilation, these are not designed nor function to stabilize and resist movement or shifting of the batteries during a shaking such as for testing or an earthquake.

Accordingly, there is a need for storage racks capable of holding backup batteries that comply with the NEBS GR-63-CORE (Issue 2 Apr. 2002) seismic testing requirements. Preferably such a system is adaptable to any standard size and array of low volt battery cells. Such a storage rack should be efficient to construct, should occupy a minimum amount of space, should be relatively light, and should be relatively affordable compared to non-NEBS certified storage systems.

### SUMMARY

The present invention includes a storage rack for receiving and securely supporting a plurality of battery cells in a spaced array. The storage rack is configured to meet the seismic testing requirements of NEBS GR-63-CORE, Section 4.1.1 (Issue 2, Apr. 2002). The present invention is further directed to providing spacing between casings of adjacent battery cells on a storage rack shelf so that the battery cells are not materially affected by bulging which often occurs in the normal course of battery cell life. At the same time, the present invention facilitates ventilation between the battery casings of adjacent cells, which is not possible using prior art rigid foam sheet spacers. Good ventilation benefits battery performance and life.

The battery storage rack includes a pair of opposed vertical frame members, each having a front edge and a rear edge with multiple horizontal shelves extending between and permanently affixed to the vertical frame members. Between each horizontal shelf layer is a rear vertical rail extending between and permanently affixed to the rear edges of the vertical frame members, and a front vertical rail extending between and removably affixed to the front edges of the vertical frame members, wherein the front and rear vertical rails are affixed opposite each other to the front edge of the vertical rails and the rear edge of the vertical rails, respectively. On the front and rear vertical rails are a plurality of opposing pairs of locking tabs designed and adapted to isolate and securely stabilize each battery cell.

An embodiment of the present invention is a storage rack for storing battery cells for an uninterrupted power source including a pair of opposing front vertical frame members having a front edge and a rear edge and a pair of opposing rear vertical frame members having a front edge and a rear edge; a plurality of horizontal shelf members extending between and permanently affixed to each pair of vertical frame members; a rear horizontal rail positioned above each horizontal shelf member, extending between and permanently affixed to the pair of opposing rear vertical frame members; a from horizontal rail positioned above each horizontal shelf member, extending between and releasably attached to the pair of front vertical frame members; and a pair of locking tabs comprising. The pair of locking tabs are in the configuration of a front locking tab and a rear locking tab where the front locking tab is affixed to the front horizontal rail and the rear locking tab is affixed to the rear horizontal rail opposite the front locking tab.

A further embodiment of the present includes a modular storage rack for securely storing an array of battery cells in an uninterrupted power source including a modular storage rack unit comprising. The modular storage rack unit includes a front horizontal rail and a rear horizontal rail and a horizontal shelf member. On each modular storage unit is at least one pair of locking tabs. Each pair of locking, tabs are configured as a front locking tab and a rear locking, tab where the front locking tab is affixed to the front horizontal rail and the rear locking tab is affixed to the rear horizontal rail opposite the front locking tab.

The modular storage rack unit embodiment of the present invention is adapted to be stacked vertically on one another and in contacting, relation to form a fully assembled modular rack.

A further embodiment of the present invention includes bee modular storage rack where each modular storage rack unit is adapted to secure multiple battery cells during transportation and assembly of a folly assembled modular rack.

Each of the embodiments of the present invention is designed to meet the seismic testing requirements of NEBS OR-63-CORE (Issue 2, Apr. 2002.

These and other aspects of the invention will be better understood from a reading of the following detailed description together with the drawings.

### BRIEF DESCRIPTION OF THE DRAWINGS

FIG. 1 is a perspective view that illustrates a unitary storage rack including pairs of opposed vertical frame members having a front edge and a rear edge as shown and horizontal shelf members attached between the vertical frame members.

FIG. 2 is a detailed view illustrating a plurality of elongated locking tabs that are integrated, by stamp forming, or other means of attachment onto or, into a horizontal rail according to the present invention.

FIG. 3 is a perspective view that shows an embodiment of a battery storage rack of the present invention without the front horizontal rail to illustrate installed battery cells and the locking tabs on the rear horizontal rail and the battery guides and ventilation holes in the horizontal shelf member.

FIG. 4 is a perspective view that shows an embodiment of the present invention, with the front horizontal rail, that illustrates the optimal separation of installed battery cells and locking of the battery cells by the locking tabs.

FIG. 5 is a top view and a perspective view that illustrates an alternate embodiment of the storage rack that is as modular storage rack incorporating the locking tabs of the present invention into a battery storage rack capable of restraining four battery cells.

FIG. 6 is a top view of a single modular storage rack unit and a perspective view illustrating an assembled modular storage rack incorporating an embodiment of the locking tabs of the present invention incorporated into a battery storage rack capable of restraining six battery cells on each horizontal shelf member.

### DETAILED DESCRIPTION

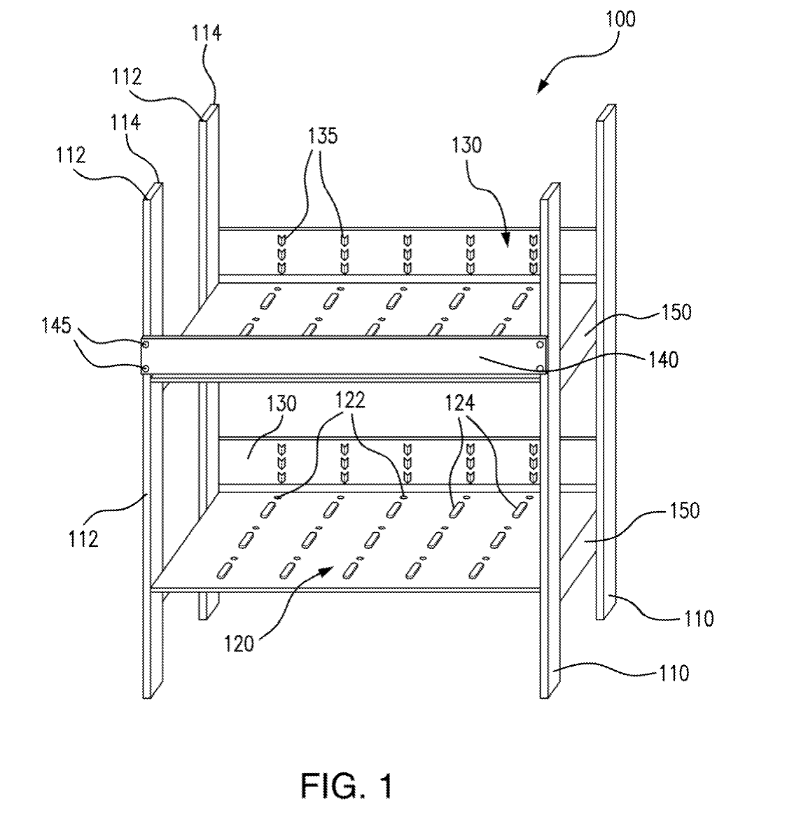

FIG. 1 is a perspective view of an embodiment of a battery storage rack illustrating the locking tabs of the present invention. The storage rack according to the present invention includes a plurality of vertically spaced horizontal shelf members for supporting objects such as battery cells in a spaced array. This embodiment shows the storage rack sized and configured to securely support and store battery cells spaced and separated by the locking tabs of the present invention along a rear horizontal rail.

FIG. 1 is a perspective view illustrating storage rack 100 including, two pairs of opposed vertical frame members 110, each vertical frame member having a front edge 112 and a rear edge 114. Generally, one pair of front opposed vertical frame members and one pair of rear opposed vertical frame members are used for each storage rack. Each vertical frame member 110 provides the structural support for the battery storage rack of the present invention. Each vertical frame member 110 may be of any suitable material including steel, strengthened aluminum, stainless steel, composite or other such material capable of structurally supporting the high weight loading from the battery cells often in excess of several hundred pounds. Preferably, vertical frame members 110 are continuous for the uniframe type storage rack 100. When constructed of steel, the storage rack realizes the benefit of steels strength and conductivity which is beneficial for secure grounding for the battery arrays.

Vertical frame members may have a cross sectional configuration of round tubular, square tubular, I-beam, or any other appropriate configuration desired that is engineered and designed appropriately for the size, weight and type of batteries, equipment or other material to be stored within the storage racks.

Vertical frame members 110 may he adapted for securing to the floor upon which the storage rack may rest to provide immovable attachment to the facility in which the storage racks are located and any typo of appropriate flange or securing mechanism may be incorporated into the vertical frame member. This may include base plates that are configured for removable or permanent attachment to a substantially planar foundation, floor, or the like.

FIG. 1 further illustrates storage rack 100 with horizontal shelf member 120 extending between opposing pairs of vertical frame members 110, horizontal shelf member 120 preferably being permanently affixed to each vertical frame member 110 by welding, bolting or other permanent attachment method. Optionally, the horizontal shelf members may be removably bolted to the vertical frame members to allow for adjustment in the height and separation between the shelf members.

Horizontal shelf member 120 is of a compatible material to the vertical frame members, preferably steel to allow for secure welding of the horizontal shelf member to the vertical frame member. The shelf members should be similarly engineered and designed to accommodate the size, weight and dimensions of the particular type of batteries, equipment or other material to be stored within the storage rack. Battery cells for the telecommunications industry in particular come in many varied sizes, shapes and weights and storage rack 100 can be modified to accommodate most such batteries. For example, horizontal shelf members may be designed and engineered to hold three, five seven or more batteries across. The more batteries arranged on a shelf member, the greater the likelihood of shifting during earth movement and the more important it is to incorporate the locking tabs and battery guides of the present invention to avoid damaging movement of the batteries during a seismic event.

The structural configuration of the horizontal shelf member may he ribbed, flat, or other accommodating shape designed to receive and support the batteries. Such ribbing extending between opposing vertical frame members provides additional strength to the shelf member and provides an opportunity to utilize thinner gauge steel and reduce the overall storage rack weight. This ribbing may be located at the front or rear edge of the shelf member or at one or more locations within the center area of the shelf member as desired for strength.

FIG. 1 further illustrates that each shelf member 120 may incorporate battery guides 134 protruding slightly above a top surface of each horizontal shelf member 120. Battery guides 124 ease receiving and removing of a battery cell while further adding strength, stability and rigidity to the horizontal shelf member of the storage rack, while reducing weight. Battery guides 124 ease receiving and removing of a battery cell by maintaining alignment of the battery as it is inserted and slid on the shelf member and into place. Battery guides may be dimples or other raised areas along the shelf member extending from the front edge of the shelf member to the rear of the shelf member designed such that they are arranged in the void space between adjacent batteries when batteries are installed in the storage rack. Battery guides need only be slightly raised above the surface, from about 0.25 inches to preferably not more that about 0.5″ above the shelf member top surface, but they could extend further above the shelf member surface as desired.

Battery guides 124 are preferably an elongated shape in the direction aligned linearly between the front and rear of the shelf member, and smooth on the top to allow for the batteries to more easily slide against the battery guide and to resist catching on any sharp edge of the guide. The battery guides may be square, trapezoidal or triangular in shape as well as may be dictated by manufacturing efficiencies or other considerations.

FIG. 1 also illustrates ventilation, openings 122 in shelf member 120 configured to be located between adjacent battery cells to aid in ventilation and heat removal from the batteries within the storage rack. Ventilation openings 122 may be located alternately between battery guides as shown in FIG. 1 and be round or oval or square in shape as desired or dictated by manufacturing efficiencies or other considerations. The ventilation openings may consist of as plurality of individual holes of any appropriate geometry along the line between adjacent battery cells as desired so long as the engineered strength of the shelf member remains adequate to support the array of battery cells and maintain the structural integrity of the shelf member and the storage rack during shaking, including seismic movement or during earthquake testing. Shelf member 120 defines each ventilation opening 122 to form the desired geometric void in the shelf member for maximum ventilation while maintaining adequate structural integrity for the storage rack to meet the seismic testing requirements of NEBS GR-63-CORE (Issue 2, Apr. 2002).

Where existing storage racks may use foam, rubber or other non-conductive materials to separate and secure battery cells in place, such materials are difficult to insert. Additionally, battery cells swell and expand over time due to the continued charging and discharging. This swelling generally occurs in the middle or central part of the battery cell causing it to bulge. As a result, while the inserts may have been difficult to insert between the new battery cells, removal of batteries or inserts is oven more difficult after the batteries have bulged. The locking tabs of the present invention allow for easier removal of the used battery cells for replacement since they do not press against the central part of each battery cell. Additionally, without the inserts to stabilize and secure the battery cells as in the present invention, there is the opportunity to add the ventilation holes to improve heat removal which in turn extends battery life by keeping, the battery cells cooler.

FIG. 1 further illustrates one embodiment of locking tabs 135 integrated into roar horizontal rail 130. Rear horizontal rail 130 is attached proximal to rear edge 114 of each vertical frame member 110 in the rear pair of opposing vertical frame members. Preferably, rear horizontal rail 130 is permanently affixed to the vertical frame member to provide optimal strength and stability to storage rack 100. A rear horizontal rail 130 may extend between the rear pair of opposing vertical frame members, each rear horizontal rail is positioned above a corresponding horizontal shelf member 120 to create a rear structural support for the storage rack and to provide for a hack resting stop for the batter cells stored within the storage rack. The rear horizontal rails, along with the shelf members, provide lateral stability to the storage rack structure as well as provide a rear enclosure to secure the batteries within the storage rack. The rear horizontal rails are designed and engineered for lateral strength capable of securing the battery cells within the shelf member area.

Rear horizontal rail members 130 should be of any compatible material to the vertical frame members, preferably steel to allow for secure welding or other strong structural attachment of the horizontal shelf member to the vertical frame member. However, the material should be compatible for attachment or integration of locking tabs 135 of the present invention. A sheet type of steel may be preferred for efficiently and economically stamping locking tabs 135 into the rear horizontal rail. Holes could also be incorporated into the rear horizontal rail such that as pin or bolt type of locking tab 135 could be bolted into the rear horizontal rail.

FIG. 1 further illustrates a plurality of front horizontal rails 140 which extend between the front pair of opposing vertical frame members 110 proximal to the front edges 112 of each vertical frame members. Each front horizontal rail 140 is positioned to extend between horizontal shelf members 120, and is preferably removably affixed to the front pair of vertical frame members proximal to the front edge 112. These front horizontal rails need not be designed to provide significant lateral structural stability, but rather are primarily to provide a front enclosure to secure the batteries within the shelf area and limit shilling of the batteries toward the front of storage rack 100. The front horizontal rails 140 also incorporate locking tabs 135 similar to locking tabs 135 on the rear horizontal rail 130. Locking tabs 135 on the front horizontal rail are opposite to and in line with those on the rear horizontal rail and designed to align between batter cells installed within the storage rack and designed to resist lateral movement of the battery cells stored within the storage rack.

The locking tabs are placed in pairs, where each pair of locking tabs comprises a front locking tab and a rear locking tab, with the front locking tab affixed to the front horizontal rail and the rear locking tab affixed to the rear horizontal rail opposite the front locking tab. The pairs of locking tabs point towards the interior of the storage rack and are aligned linearly across from each other.

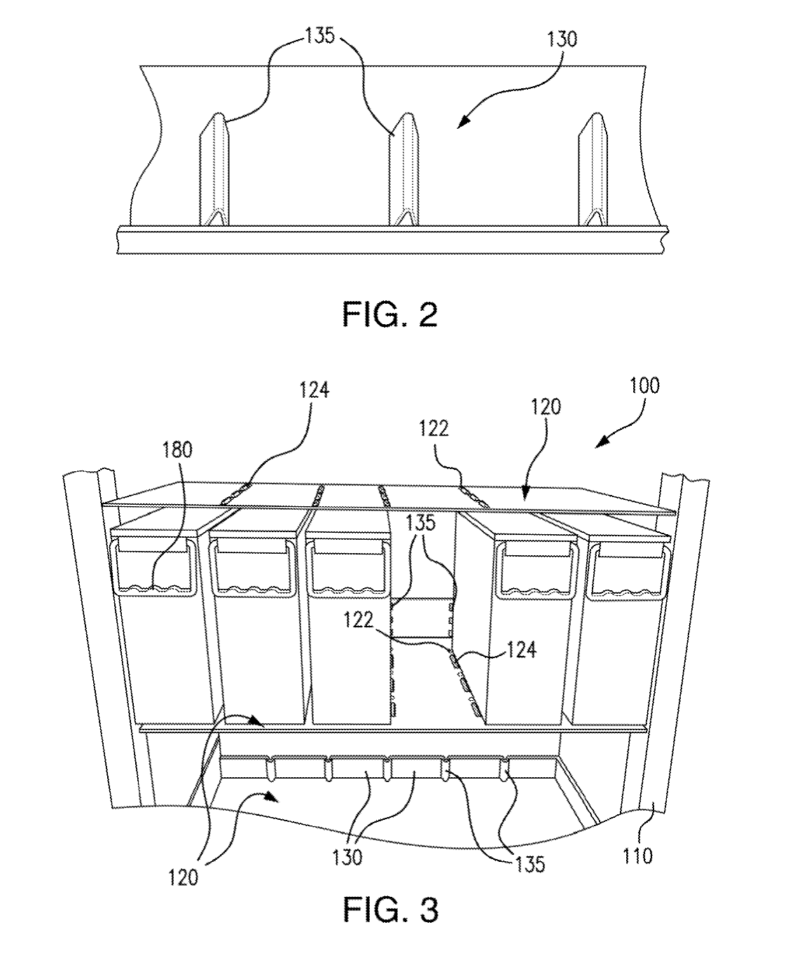

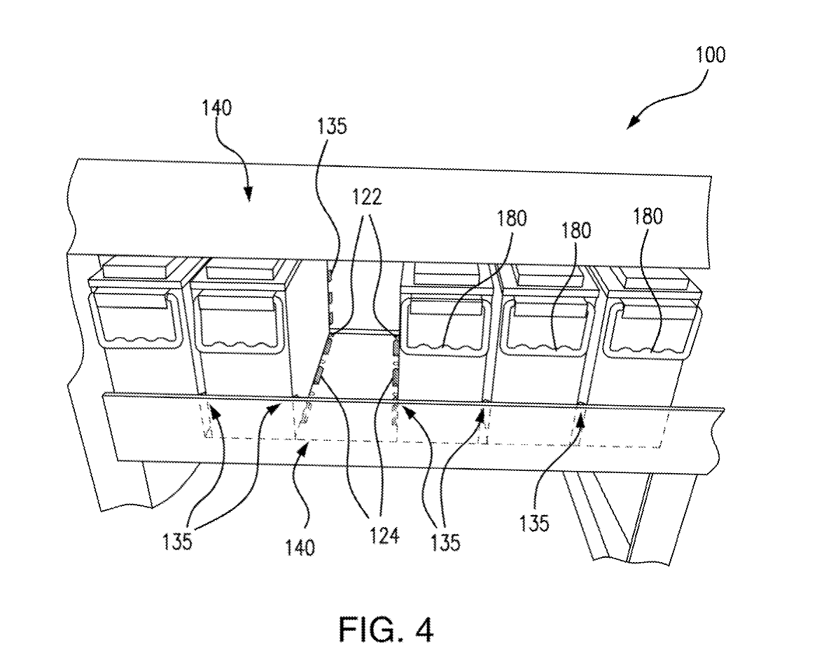

Multiple pairs of locking tabs are preferably spaced apart according to the width of the battery cells to be installed. The locking tabs along a horizontal rail are laterally separated and positioned, depending upon the width of the type of battery cell to be installed, to align between two inserted battery cells. The locking tabs should be tightly compressed by adjacent battery cells such that the battery cells are locked into place by the locking tabs. Each battery cell after insertion should not be able to move laterally on the horizontal shelf member. There needs to be at least one pair of locking tabs between every two battery cells. If smaller individual locking tabs such as illustrated in FIG. 1 or FIG. 3 are incorporated then it is preferred that more than one pair of locking tabs be aligned between every two battery cells. If the locking tabs are larger individual locking tabs such as illustrated in FIG. 2, then only a single locking tab may be necessary.

Additional pairs of locking tabs may be used to secure a single side of a battery cell such as near the vertical frame members if the battery cells do not come in contact with the vertical rails or other horizontal side member. In this manner the outer battery cells may be secured in place by locking tabs without the need of an extra horizontal side member, or side reinforcing rail 150, to restrain the exposed side of the battery cell.

Additional rear horizontal rails or front horizontal rails may be used between each shelf to provide additional security and stability to the battery cells depending upon their size and shape. These additional horizontal rails may contain pairs of locking tabs to contact the battery cells and further stabilize the storage rack during movement.

Front horizontal members should be of any compatible material to the vertical frame members, preferably steel and are designed and engineered for lateral strength capable of securing the batteries within the shelf area. However, the material should be compatible for attachment or integration of the locking tabs of the present invention. A sheet type of steel may be preferred for stamping or welding the locking tabs into the rear horizontal rail. Holes could also be incorporated into the rear horizontal rail such that a locking tab could he bolted into the rail.

The front horizontal rail 140 is designed to be removably affixed proximal to the front edge 112 of the front pair of opposing vertical frame members 110. This allows for the front vertical rail to be removed and replaced to access, remove and replace the batteries as needed. This removable attachment may be by a simple bolting system, hinge or other latching mechanism that securely attaches the front horizontal rail to each of the front vertical frame members or it may be more complex bolt and sleeve or latching mechanism.

Side reinforcing rails 150 may also be installed between each pair of opposing front and rear vertical frame members to provide additional structural integrity to storage rack 100 as shown in FIG. 1.

FIG. 2 is a detailed perspective view illustrating a further more detailed embodiment of the locking tabs of the present invention showing a plurality of longer, elongated locking tabs 135 integrated, by stamp forming, into rear horizontal rail 130. In FIG. 2 the locking tabs are a longer individual formed tab extending the surface of the horizontal rail. The length of each elongated locking tab should preferably contact between two adjacent battery cells such that each inserted battery cell will not lean or tip as well as not shift laterally within the horizontal shelf compartment. The elongated locking tab should preferably contact near the bottom of an inserted battery cell. More preferably, the locking tab should contact the battery cells near the bottom and near the top of each battery cells for optimal stabilization. When smaller locking tabs arc used, the cumulative length of the smaller individual locking tabs should also contact between every two adjacent battery cells such that each inserted battery cell will not lean, tip or shift laterally within the horizontal shelf compartment. The elongated locking tab shown in FIG. 2 may be used to prevent battery cell movement to pass required testing certifications.

A plurality of pairs of opposing locking tabs 135 are on or within the rear horizontal rails and the front horizontal rails, each one locking tab of a pair affixed opposite the other on the front horizontal, rails and the rear horizontal rails. These tabs should be structurally sound such that they do not bend under the weight of moving batteries so as to secure and stabilize the battery arrays from shafting or moving, especially as during an earthquake. The locking tabs may be integrated into the vertical rails by stamping the metal used for the vertical rail to incorporate the locking tab into the metal itself or the locking tab may be preformed and then bolted or welded onto the vertical rail, although this may incorporate additional cost into the finished storage rack.

The locking tabs can be form stamped, punch cut and bent directly into rear horizontal rail 130 or may be attached or inserted into horizontal rails as desired by manufacturing efficiency and economy. The locking tabs may protrude from the surface of the horizontal rail enough to just pass the face of the battery cell and secure against the sides of the battery cells. The material forming the walls of the battery cells are generally rigid and the locking tab will resist movement of the battery during movement of the rack during transportation of a loaded rack or during a seismic event. Preferably, the locking tab should extend about 0.5 in. to about 1.5 in. from the surface of the horizontal rail. An individual locking tab 135 may extend as little as about 0.25 inch from the vertical rail, so as to extend just beyond the face of an inserted battery cell on a horizontal shelf member. The locking tab may extend as far as half the distance to the center line of the shelves between which it is located, which may be about 12 inches, to 24 inches or more depending upon the length of the batteries. However, it is preferred that the length of the locking tab not extend more than about two inches and more preferably less than one inch so as to allow more ventilation and importantly not provide a protrusion that may interfere with the battery casing when the battery swells or bulges during use. The locking tab on the horizontal rail may be located at about half way between the height between shelves or half the height of an individual battery. In this location the locking tab may most effectively resist the shifting of the battery and keep it secure.

Locking tab 135 may be any one of several shapes from a simple rod or pin, to a more complex triangular, conical or trapezoidal shape so as to more easily receive and lock a battery into place. The width of the locking tab may be not less than about 0.5 inches so as to allow adequate air flow between the batteries for cooling. The width may be as wide as desired in order to provide greater ventilation or for other purposes to provide the desired spacing between batteries. Sharp points or edges should be avoided to limit any potential damage to a battery as it is received to storage rack.

The location of the locking tabs should he configured such that each tab is located between each battery, with a companion locking tab on the opposite horizontal rail.

The locking tabs will resist movement of the battery during as shaking of the storage rack such as from an earthquake. As the battery array is electrically interconnected with heavy gage cables or plates, there is little tolerance for such movement without the risk of disconnecting, breaking or shorting of the cables and connections.

FIG. 3 is a perspective view illustrating storage rack 100 partially loaded with a plurality of battery cells 180 inserted into and resting upon horizontal shelf member 120. This embodiment of the present invention does not illustrate the front horizontal rail in order to show the separation between each battery cell 180, location of locking tabs 135 against the side of each battery cell 180, and the location of battery guides 124 adjacent to and in contact with each inserted battery cell 180. Battery guides 124 assist in the insertion and removal of battery cells as well as aid in resisting battery movement during movement of the storage rack. FIG. 3 further illustrates ventilation holes 122 between battery cells 180 that allows for greater circulation of heated air created by the charging and discharging of the batteries.

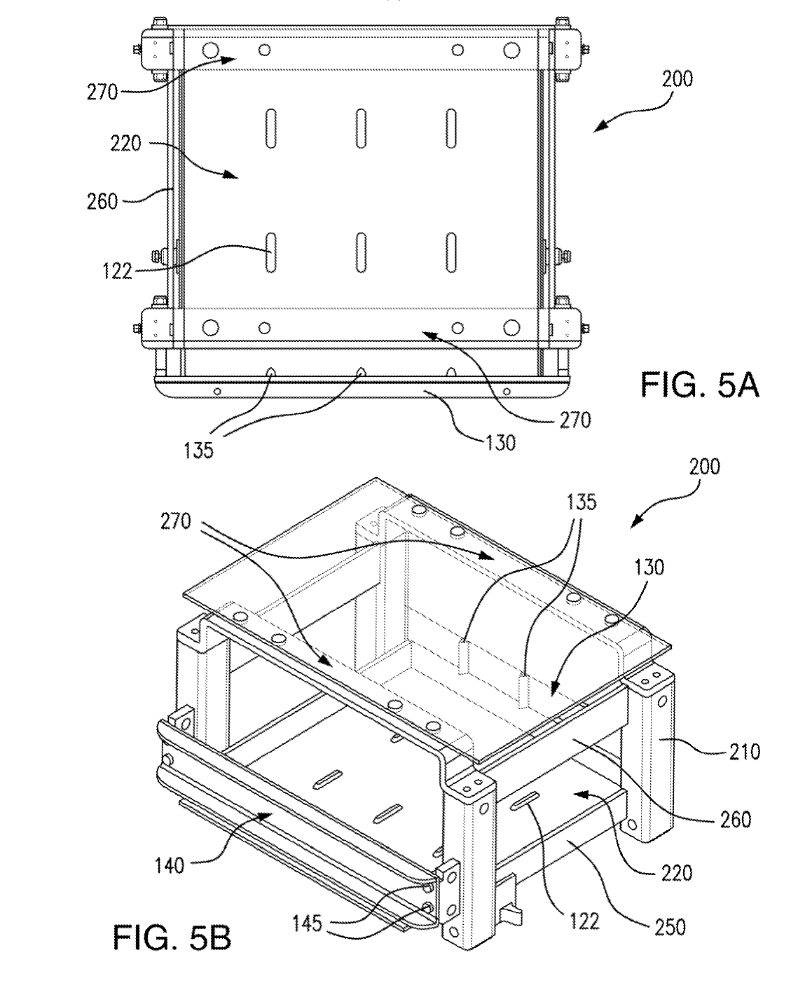

FIG. 4 is a perspective view illustrating storage rack 100 partially loaded with to plurality of battery cells 180 and locking tabs 135 on front horizontal rail 140 providing optimal separation and locking of individual battery cells 180 by the locking tabs 135. As shown the locking tabs conical, trapezoidal, triangular or other similar shape guide each individual battery cell into its proper position against the rear horizontal rail and “locks” each battery cell into place when front horizontal rail is attached and secured in place. After locking each battery cell 180 into place, the locking tabs then resists movement of the battery cell 180 during a shaking event that would otherwise allow the battery cell to shift and potentially disconnect it from terminals, cables or other electrical connection.

The storage rack of FIG. 1 is designed and constructed to meet or surpass the seismic testing requirements of NEBS GR-63-CORE, Section 4.1.1 (Issue 2, Apr. 2002). More specifically, the storage rack is designed and constructed to sustain the waveform testing defined by NEBS GR-63-CORE without permanent structural or mechanical damage.

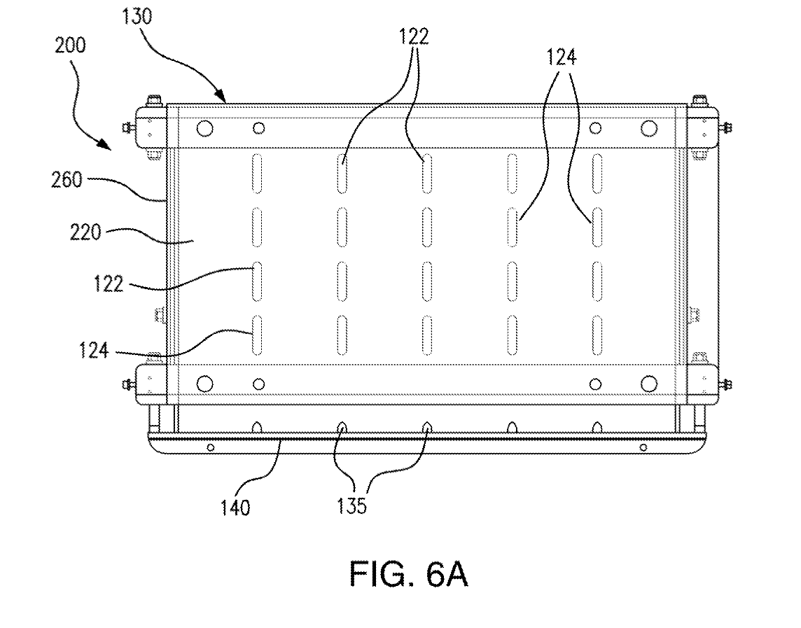

FIG. 5 provides a perspective view that illustrates further embodiments of the locking tabs of the present invention incorporated into modular battery storage racks 200 capable of containing four battery cells 180. The modular battery storage rack 200 illustrated in FIG. 5 are modular in design with a plurality of modular storage racks 200 capable of being vertically stacked on each other for ease of moving of the battery storage rack in smaller pieces. In addition, such modular sections can be pre-loaded with batteries and then moved to a site where the pre-loaded modular storage racks are stacked and quickly installed.

Modular storage rack unit 200 is shown in a top down view in FIG. 5A illustrating top reinforcing cross member 270. Further illustrated in FIG. 5A are ventilation holes 122 in horizontal shelf member 220 aligned to be between each battery cell 180 when installed into a modular storage rack unit. Locking tabs 135 are shown extending from the surface of rear horizontal rail 130 in line with ventilation holes 122 designed to contact between adjacent battery cells when installed. Optional upper side reinforcing member 200 is shown, which is designed to provide additional structural integrity to the modular storage rack unit 200.

FIG. 5B provides a perspective view of modular storage rack unit 200 showing optional upper side reinforcing member 260 and lower side reinforcing member 250, which are designed to provide further structural integrity to the modular storage rack unit 200, especially when fully pre-loaded with battery cells. Front horizontal rail 140 is shown releasably attached to the modular storage rack unit 200 by attachment bolts 145. This embodiment of storage rack is shown to hold four battery cells per shelf in each modular storage unit 200. Multiple modular storage unit 200 may be stacked upon each other to form fully assembled storage racks.

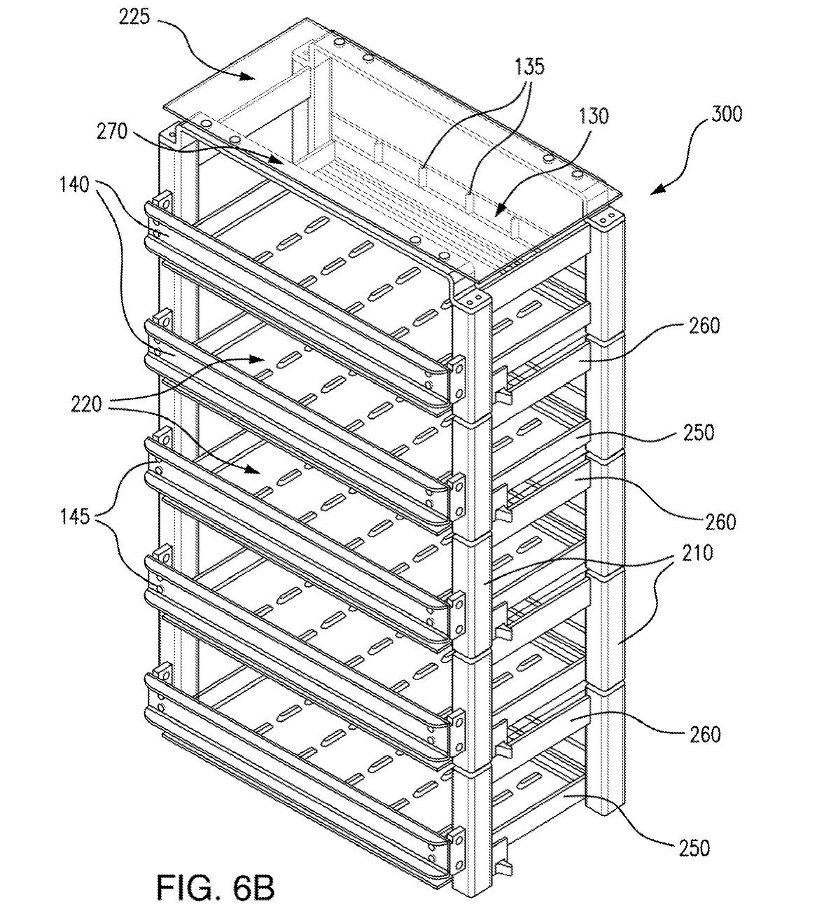

FIG. 6 illustrates a further embodiment of the present invention. FIG. 6A is a to view of a single modular storage rack unit 200 which is designed to hold six battery cells per shelf. Here, horizontal shelf member 220 is shown with alternating ventilation holes 122 and battery guides 124. FIG. 6A further illustrates the locking tabs along the front horizontal rail and their alignment with the elongated ventilation openings 122 and battery guides 124 on horizontal shelf member 220. This arrangement allows for the ventilation openings to be optimally positioned between the battery cells for cooling of the battery cells.

FIG. 6B is a perspective view of multiple modular storage rack units 200 stacked upon each other to form fully assembled storage rack 300. Front horizontal rail 140 is shown releasably attached to each vertical frame member 210 by attachment bolts 145. Upper side reinforcing member 260 and lower side reinforcing member 250 are shown for each modular storage rack unit 200. On top of a fully assembled storage rack 300 may be an optional top shelf 225.

The above detailed description of exemplary embodiments of the present invention is provided to illustrate the various aspects of the invention, and is not intended to limit the scope of the invention thereto. Persons of ordinary skill in the art will recognize that certain modifications can be made to the described embodiments without departing from the invention. For example, while the above-described embodiments of the invention have been principally described in connection with the storage of battery cells for backup power systems, a storage system according to the invention may also be configured and used to support, other objects or equipment. All such modifications are intended to be within the scope of the appended claims

What is claimed is:

1. A storage rack for securely storing battery cells comprising:
a. a storage rack; and
b. a plurality of locking tabs.

2. The storage rack of claim 1 further comprising a plurality of ventilation holes.

3. The storage rack of claim 1 further comprising a plurality of battery guides.

4. The storage rack of claim 1 wherein the storage rack meets the seismic testing requirements of NEBS GR-63-CORE (Issue 2, Apr. 2002).

5. A storage rack for storing battery cells for an uninterrupted power source, the storage rack comprising:
a. a pair of opposing front vertical, frame members having a front edge and a rear edge and a pair of opposing rear vertical frame members basing a front edge and a rear edge;
b. as plurality of horizontal shelf members extending between and permanently affixed to each pair of vertical frame members;
c. a rear horizontal rail positioned above each horizontal shelf member, extending between and permanently affixed to the pair of opposing rear vertical frame members;
d. as front horizontal rail positioned above each horizontal shelf member, extending between and releasably attached to the pair of front vertical frame members;
e. a pair of locking tabs comprising:
i. a front locking tab; and
ii. a rear locking tab; and
wherein the front locking tab is affixed to the front horizontal rail and the rear locking tab is affixed to the rear horizontal rail opposite tile front locking tab.

6. The storage of claim 5 comprising a plurality of pairs of locking tabs.

7. The storage rack of claim 5 wherein the storage rack meets the seismic testing requirements of NEBS GR-63-CORE (Issue 2, Apr. 2002).

8. The storage rack of claim 5 wherein the locking tabs are stamped formed into each horizontal rail.

9. The storage rack of claim 5 wherein the locking tabs extend less than 0.50 inches from an interior face of the rear horizontal rail and the front horizontal rail.

10. The storage rack of claim 5 wherein the locking tabs extend less than 1.00 inch from an interior face of the rear horizontal rail and the front horizontal rail.

11. The storage rack of claim 5 wherein the locking tabs are integrated into the rear horizontal rail.

12. A modular storage rack for securely storing an array of battery cells in an uninterrupted power source comprising:
a. a modular storage. rack unit comprising;
i. a front horizontal rail;
ii. a rear horizontal rail; and
iii. a horizontal shelf member;
b. a pair of locking tabs comprising a front locking tab and a rear locking tab; and
wherein the front locking tab is affixed to the front horizontal rail and the rear locking tab is affixed to the rear horizontal rail opposite the front locking tab.

13. The modular storage rack of claim 12 comprising, a plurality of pairs of locking tabs.

14. The modular storage rack of claim 12 further comprising a plurality of ventilation holes formed in the horizontal shelf member.

15. The modular storage rack of claim 12 further comprising a plurality of battery guides formed in the horizontal shelf member.

16. The modular storage rack of claim 12 comprising at least two modular storage rack units arranged vertically and in contacting relation to form a fully assembled modular rack.

17. The modular storage rack of claim 16 wherein the fully assembled modular rack storage rack meets the seismic testing requirements of NEBS GR-63-CORE (Issue 2, Apr. 2002).

18. The modular storage rack of claim 12 wherein the modular storage rack unit is adapted to secure multiple battery cells during transportation and assembly of a fully assembled modular rack.

19. The modular storage rack of claim 12 wherein the modular storage rack meets the seismic testing requirements of NEBS GR-63-CORE (Issue 2, Apr. 2002).
